(19) United States
(12) Patent Application Publication
(10) Pub. No.: US 2025/0114902 A1
(43) Pub. Date: Apr. 10, 2025

(54) HORIZONTAL PRE-CLEAN 2-STAGE DOWNFORCE MECHANISM WITH FLEXURE

(71) Applicant: Applied Materials, Inc., Santa Clara, CA (US)

(72) Inventors: Avyay Panchapakesan, San Jose, CA (US); Jagan Rangarajan, San Jose, CA (US); Steven M. Zuniga, Soquel, CA (US); Edward Golubovsky, San Jose, CA (US); Aliya Kassam Pirbhai, Emeryville, CA (US)

(73) Assignee: Applied Materials, Inc., Santa Clara, CA (US)

(21) Appl. No.: 18/483,971

(22) Filed: Oct. 10, 2023

(51) Int. Cl. B24B 37/30; B24B 37/04; F15B 15/14

(52) U.S. Cl. CPC B24B 37/30; B24B 37/042; F15B 15/14

(57) ABSTRACT

Exemplary chemical mechanical cleaning systems may include a carrier head. The systems may include a motor that is coupled with the carrier head. The motor may be operable to rotate the carrier head about a central axis of the carrier head. The systems may include a two-stage downforce actuator that is operable to vertically translate the carrier head and the motor between a raised position and a cleaning position. The downforce actuator may include a first stage that includes a linear actuator that is operable to vertically translate the carrier head between the raised position and at least an upper 50% of a vertical travel distance between the raised and cleaning positions. The downforce actuator may include a second stage that includes an expandable flexure that is operable to vertically translate the carrier head between the cleaning position and no greater than a lower 50% of the vertical distance.

### TECHNICAL FIELD

The present technology relates to semiconductor systems, processes, and equipment. More specifically, the present technology relates to cleaning film deposited on a substrate.

### BACKGROUND

An integrated circuit is typically formed on a substrate by the sequential deposition of conductive, semiconductive, and/or insulative layers on a silicon wafer. A variety of fabrication processes use the planarization of a layer on the substrate between processing steps. For example, for certain applications, e.g., polishing of a metal layer to form vias, plugs, and/or lines in the trenches of a patterned layer, an overlying layer is planarized until the top surface of a patterned layer is exposed. In other applications, e.g., planarization of a dielectric layer for photolithography, an overlying layer is polished until a desired thickness remains over the underlying layer.

In some embodiments, pre-cleaning is required to remove contaminant particles through low-magnitude downforce against a cleaning or polishing pad. This cleaning method typically requires that the substrate be mounted on a carrier or polishing head. The exposed surface of the substrate is typically placed against a rotating pad. The carrier head provides a controllable load on the substrate to push it against the pad.

One problem in such cleaning operations is uniformly cleaning the entire surface of the substrate. Oftentimes, due to the design of downforce actuators of the cleaning systems it may be difficult to consistently control a magnitude of downforce applied to a backside of the substrate, which may make it difficult to consistently clean substrates within a batch. For example, when substrates are pressed downward upon a cleaning pad with different amounts of downforce, cleaning rates may vary (e.g., higher downforces may result in greater cleaning rates), which may negatively impact the system's ability to produce uniformly cleaned substrates with and may impact the final semiconductor product.

Thus, there is a need for improved systems and methods that can be used to clean substrates to uniformly clean an entire surface area of a batch of substrates. These and other needs are addressed by the present technology.

### SUMMARY

Exemplary substrate cleaning systems may include a carrier head. The systems may include a motor that is coupled with the carrier head. The motor may be operable to rotate the carrier head about a central axis of the carrier head. The systems may include a two-stage downforce actuator that is operable to vertically translate the carrier head and the motor between a raised position and a cleaning position. The two-stage downforce actuator may include a first stage that includes a linear actuator that is operable to vertically translate the carrier head and the motor between the raised position and at least an upper 50% of a vertical travel distance between the raised position and the cleaning position. The two-stage downforce actuator may include a second stage that includes an expandable flexure that is operable to vertically translate the carrier head and the motor between the cleaning position and no greater than a lower 50% of the vertical distance between the raised position and the cleaning position.

In some embodiments, the linear actuator may include a pneumatic actuator. The expandable flexure may expand to vertically transfer the carrier head and the motor downward. The expandable flexure may contract to vertically transfer the carrier head and the motor upward. A top end of the expandable flexure may define a fluid inlet port. The fluid inlet port may be fluidly coupled with a fluid source. A top end of the expandable flexure may be coupled with a shaft of the motor and a bottom end of the expandable flexure may be coupled with a shaft of the carrier head. A portion of a carrier head shaft that extends above the expandable flexure may include a shoulder that forms a hard stop when a top surface of the expandable flexure presses against the shoulder. The expandable flexure may include a dual flexure that includes an expandable top surface and an expandable bottom surface. The expandable flexure may include a peripheral edge. The expandable flexure may include an upper mounting hub that is coupled with the motor. The expandable flexure may include an upper flexible wall that extends between and couples the peripheral edge with the upper mounting hub. The expandable flexure may include a lower mounting hub that is coupled with the carrier head. The expandable flexure may include a lower flexible wall that extends between and couples the peripheral edge with the lower mounting hub. The first stage may include a hard stop that limits a downward travel position of the linear actuator. The systems may include a cleaning pad disposed below the carrier head. The expandable flexure may include polyetheretherketone (PEEK).

Some embodiments of the present technology may encompass two-stage downforce actuators. The actuators may include a first stage that includes a linear actuator that is operable to vertically translate a carrier head and a motor between a raised position and at least an upper 50% of a vertical travel distance between the raised position and a cleaning position. The actuators may include a second stage that includes an expandable flexure that is operable to vertically translate the carrier head and the motor between the cleaning position and no greater than a lower 50% of the vertical distance between the raised position and the cleaning position.

In some embodiments, the expandable flexure may expand to vertically transfer the carrier head and the motor downward. The expandable flexure may contract to vertically transfer the carrier head and the motor upward. The expandable flexure may define an interior fluid chamber between a top wall and a bottom wall of the expandable flexure. In a contracted state, inner surface of the top wall and inner surface of the bottom wall may be in contact. In a contracted state, inner surface of the top wall and inner surface of the bottom wall may be vertically spaced apart. A peripheral edge of the expandable flexure that extends about an interior fluid chamber of the expandable flexure may include thickened walls relative to flexible portions of the top wall and the bottom wall that bound the interior fluid chamber. The top wall of the expandable flexure may include an upper mounting hub. The bottom wall of the expandable flexure may include a lower mounting hub.

Some embodiments of the present technology may encompass methods of cleaning a substrate. The methods may include positioning a substrate within a carrier head of a cleaning system. The methods may include lowering the carrier head and the substrate toward an upper surface of a pad without contacting the upper surface of the pad. The methods may include inflating an expandable flexure of the cleaning system to move the carrier head downward to press the substrate against the upper surface of the pad. The methods may include cleaning the substrate against the upper surface of the pad. In some embodiments, inflating the expandable flexure may include pumping a fluid into an interior fluid chamber of the expandable flexure such that a bottom surface of the expandable flexure presses against an upper surface of the carrier head to press the carrier head and the substrate downward against the pad.

Such technology may provide numerous benefits over conventional systems and techniques. For example, the cleaning systems described herein may apply more repeatable and finely tuned downforce from substrate to substrate. This may enable the uniformity of cleaning to be improved across the surface of each substrate of a batch of substrates, which may lead to increased die yield. These and other embodiments, along with many of their advantages and features, are described in more detail in conjunction with the below description and attached figures.

### BRIEF DESCRIPTION OF THE DRAWINGS

A further understanding of the nature and advantages of the disclosed technology may be realized by reference to the remaining portions of the specification and the drawings.

FIG. 1 shows a schematic cross-sectional view of an exemplary cleaning system according to some embodiments of the present technology.

FIG. 2A shows a schematic partial cross-sectional view of an exemplary two-stage downforce actuator in a raised position according to some embodiments of the present technology.

FIG. 2B shows a schematic partial cross-sectional view of the two-stage downforce actuator of FIG. 2A in a partially lowered position.

FIG. 2C shows a schematic partial cross-sectional view of the two-stage downforce actuator of FIG. 2A in a cleaning position.

FIG. 3A illustrates a schematic cross-sectional view of an exemplary expandable flexure in a contracted state according to some embodiments of the present technology.

FIG. 3B illustrates a schematic cross-sectional view of the expandable flexure of FIG. 3A in an expanded state.

FIG. 3C illustrates a schematic cross-sectional view of an exemplary expandable flexure in a contracted state according to some embodiments of the present technology.

FIG. 3D illustrates a schematic cross-sectional view of the expandable flexure of FIG. 3C in an expanded state.

FIG. 3E illustrates a schematic cross-sectional view of an exemplary expandable flexure in a contracted state according to some embodiments of the present technology.

FIG. 3F illustrates a schematic cross-sectional view of the expandable flexure of FIG. 3E in an expanded state.

FIG. 4 is a flowchart of an exemplary method of cleaning a substrate according to some embodiments of the present technology.

Several of the figures are included as schematics. It is to be understood that the figures are for illustrative purposes and are not to be considered of scale unless specifically stated to be of scale. Additionally, as schematics, the figures are provided to aid comprehension and may not include all aspects or information compared to realistic representations and may include exaggerated material for illustrative purposes.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the letter.

### DETAILED DESCRIPTION

In conventional cleaning operations it is often difficult to uniformly clean the surface of a substrate to remove contaminant particles. Conventional substrate cleaning involves a substrate being positioned face down on a cleaning pad, with a carrier that holds the substrate against a rotating cleaning or polishing pad. To help facilitate cleaning operations, downforce may be applied to a backside of the substrate to press a face of the substrate against the pad. In conventional cleaning systems, the downforce is applied using a downforce actuator that moves a carrier head holding the substrate and a motor of the carrier head downward toward the pad. Such actuators utilize sliding components, such as bearings or slide rails, to facilitate the vertical translation of the carrier head and motor. However, sliding motion between the translation components generates friction force between the components that may make it difficult to repeatably apply a consistent downforce. Additionally, the sliding components may experience stiction that may greatly impact the ability of the actuator to consistently apply a desired magnitude of downforce from one substrate to another. Inconsistent downforce application from substrate to substrate may result in a batch of substrates using the cleaning system to be cleaned to different degrees and may reduce the quality of the final semiconductor devices produced from such substrates.

The present technology overcomes these issues with conventional cleaning systems by using a two-stage downforce actuator that uses a second stage to lower the substrate against the substrate against a cleaning pad without the use of sliding components. For example, a first stage may include one or more sliding mechanism to coarsely lower the substrate over at least half of the travel range of the carrier head and motor. A second stage of the actuator may use an expanding flexure that lowers the substrate the last portion of the travel range of the carrier head to position the substrate against the pad without generating friction force. This may enable the actuator to more repeatably control a downforce applied to the substrate, which may improve the consistency of cleaning operations for each substrate cleaned by the cleaning system.

Although the remaining disclosure will routinely identify specific film cleaning processes utilizing the disclosed technology, it will be readily understood that the systems and methods are equally applicable to a variety of other semiconductor processing operations and systems. Accordingly, the technology should not be considered to be so limited as for use with the described cleaning systems or processes alone. For example, the downforce actuators described herein may be utilized to provide downforce on substrates in cleaning operations. The disclosure will discuss one possible system that can be used with the present technology before describing systems and methods or operations of exemplary process sequences according to some embodiments of the present technology. It is to be understood that the technology is not limited to the equipment described, and processes discussed may be performed in any number of processing chambers and systems, along with any number of modifications, some of which will be noted below.

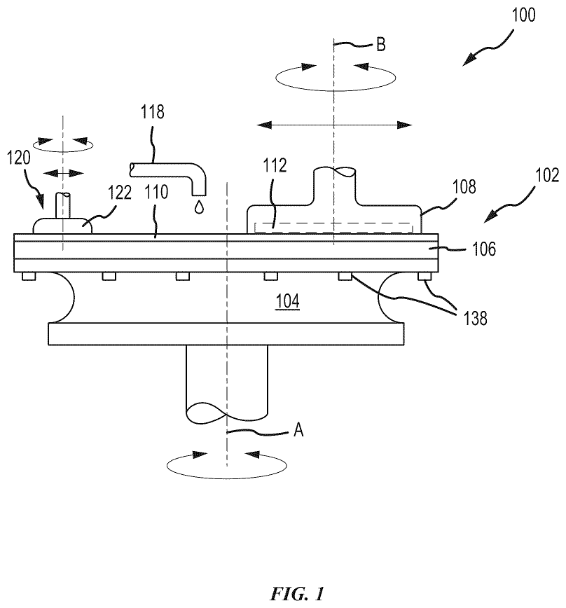

FIG. 1 shows a schematic cross-sectional view of an exemplary cleaning system 100 according to some embodiments of the present technology. Cleaning system 100 includes a platen assembly 102, which includes a lower platen 104 and an upper platen 106. Lower platen 104 may define an interior volume or cavity through which connections can be made, as well as in which may be included end-point detection equipment or other sensors or devices, such as eddy current sensors, optical sensors, or other components for monitoring cleaning and/or polishing operations or components. For example, and as described further below, fluid couplings may be formed with lines extending through the lower platen 104, and which may access upper platen 106 through a backside of the upper platen. Platen assembly 102 may include a cleaning or polishing pad 110 mounted on a first surface of the upper platen. A substrate carrier 108, or carrier head, may be disposed above the cleaning pad 110 and may face the cleaning pad 110. The platen assembly 102 may be rotatable about an axis A, while the substrate carrier 108 may be rotatable about an axis B. The substrate carrier may also be configured to sweep back and forth from an inner radius to an outer radius along the platen assembly, which may, in part, reduce uneven wear of the surface of the cleaning pad 110. The cleaning system 100 may also include a fluid delivery arm 118 positioned above the cleaning pad 110, and which may be used to deliver cleaning and/or polishing fluids, such as a cleaning slurry, onto the cleaning pad 110. Additionally, a pad conditioning assembly 120 may be disposed above the cleaning pad 110 and may face the cleaning pad 110.

In some embodiments of performing a cleaning process, the rotating and/or sweeping substrate carrier 108 may exert a downforce against a substrate 112, which is shown in phantom and may be disposed within or coupled with the substrate carrier. The downward force applied may depress a material surface of the substrate 112 against the cleaning pad 110 as the cleaning pad 110 rotates about a central axis of the platen assembly. The interaction of the substrate 112 against the cleaning pad 110 may occur in the presence of one or more cleaning fluids delivered by the fluid delivery arm 118. A typical cleaning fluid may include a slurry formed of an aqueous solution in which abrasive particles may be suspended. Often, the cleaning fluid contains a pH adjuster and other chemically active components, such as an oxidizing agent, which may enable cleaning of the material surface of the substrate 112.

The pad conditioning assembly 120 may be operated to apply a fixed abrasive conditioning disk 122 against the surface of the cleaning pad 110, which may be rotated as previously noted. The conditioning disk may be operated against the pad prior to, subsequent, or during cleaning of the substrate 112. Conditioning the cleaning pad 110 with the conditioning disk 122 may maintain the cleaning pad 110 in a desired condition by abrading, rejuvenating, and removing polish byproducts and other debris from the cleaning surface of the cleaning pad 110. Upper platen 106 may be disposed on a mounting surface of the lower platen 104, and may be coupled with the lower platen 104 using a plurality of fasteners 138, such as extending through an annular flange shaped portion of the lower platen 104.

The cleaning platen assembly 102, and thus the upper platen 106, may be suitably sized for any desired cleaning system, and may be sized for a substrate of any diameter, including 200 mm, 300 mm, 450 mm, or greater. For example, a cleaning platen assembly configured to polish 300 mm diameter substrates, may be characterized by a diameter of more than about 300 mm, such as between about 500 mm and about 1000 mm, or more than about 500 mm. The platen may be adjusted in diameter to accommodate substrates characterized by a larger or smaller diameter, or for a cleaning platen 106 sized for concurrent cleaning of multiple substrates. The upper platen 106 may be characterized by a thickness of between about 20 mm and about 150 mm and may be characterized by a thickness of less than or about 100 mm, such as less than or about 80 mm, less than or about 60 mm, less than or about 40 mm, or less. In some embodiments, a ratio of a diameter to a thickness of the cleaning platen 106 may be greater than or about 3:1, greater than or about 5:1, greater than or about 10:1, greater than or about 15:1, greater than or about 20:1, greater than or about 25:1, greater than or about 30:1, greater than or about 40:1, greater than or about 50:1, or more.

The upper platen and/or the lower platen may be formed of a suitably rigid, light-weight, and cleaning fluid corrosion-resistant material, such as aluminum, an aluminum alloy, or stainless steel, although any number of materials may be used. Cleaning pad 110 may be formed of any number of materials, including polymeric materials, such as polyurethane, a polycarbonate, fluoropolymers, polytetrafluoroethylene polyphenylene sulfide, or combinations of any of these or other materials. Additional materials may be or include open or closed cell foamed polymers, elastomers, felt, impregnated felt, plastics, or any other materials that may be compatible with the processing chemistries. It is to be understood that cleaning system 100 is included to provide suitable reference to components discussed below, which may be incorporated in system 100, although the description of cleaning system 100 is not intended to limit the present technology in any way, as embodiments of the present technology may be incorporated in any number of cleaning systems that may benefit from the components and/or capabilities as described further below.

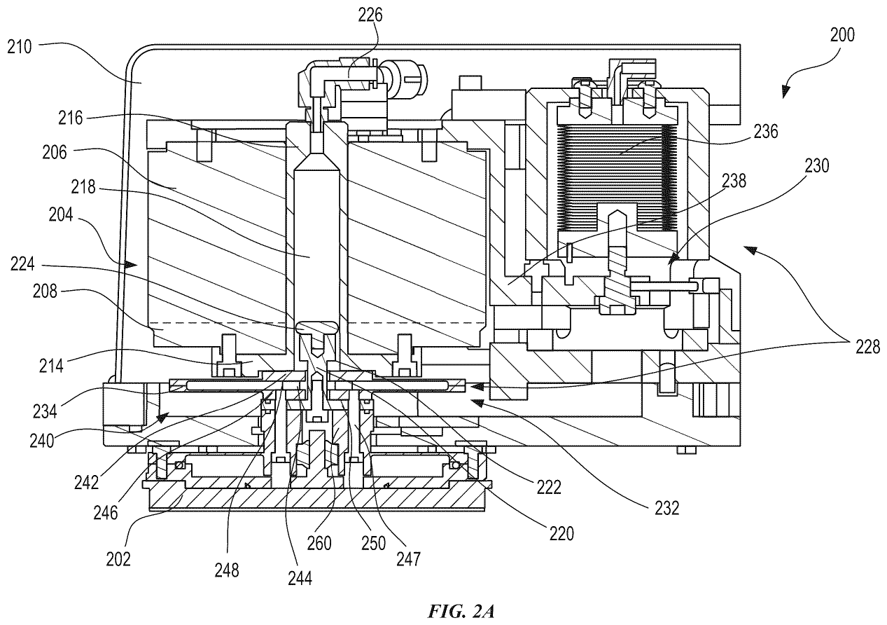

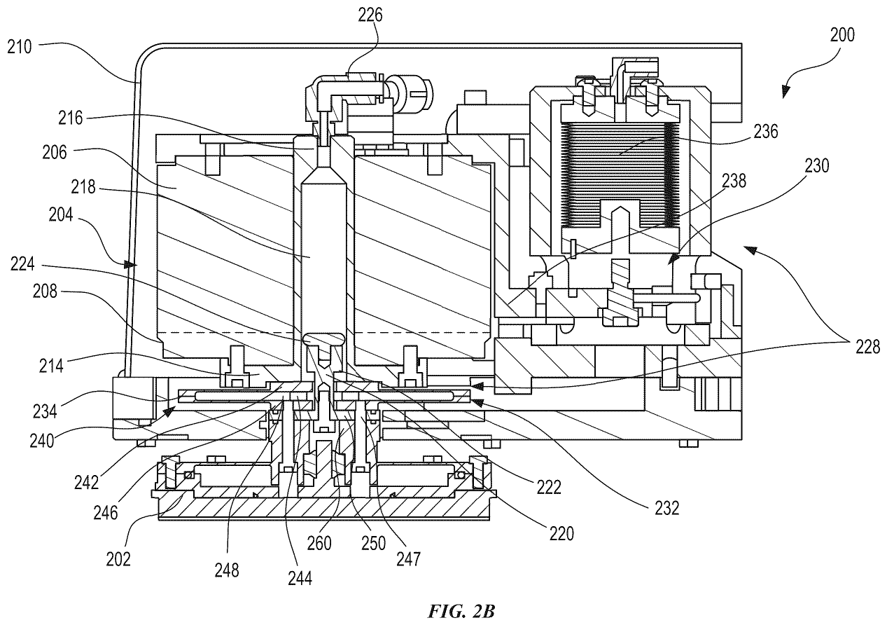

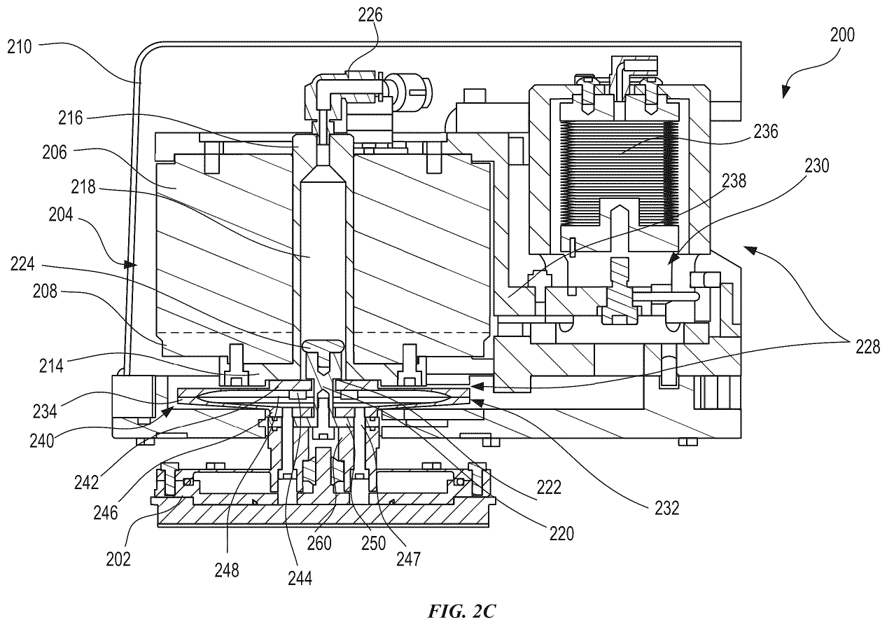

FIGS. 2A-2C illustrate schematic cross-sectional side elevation views of an exemplary cleaning system 200 according to some embodiments of the present technology. Cleaning system 200 may show a partial view of the components being discussed and that may include any components described in relation to cleaning system 100. Cleaning system 200 may include a carrier head 202. Carrier head 202 may be used as substrate carrier 108 in some embodiments and may include any feature described in relation to substrate carrier 108. Carrier head 202 may be coupled with a motor 204 that is operable to rotate carrier head 202 about a central axis of carrier head 202 during cleaning operations. Motor 204 may include a fixed portion 206 and a rotatable portion 208 that is rotatable relative to fixed portion 206. For example, fixed portion 206 may include a stator assembly that is coupled with a housing 210 of cleaning system 200. When current is supplied to the stator assembly, the stator assembly may produce a rotating magnetic field that causes rotatable portion 208 to rotate relative to fixed portion 206 and housing 210. Carrier head 202 may be coupled with rotatable portion 208, such as using one or more fasteners (such as bolts or screws) that extend through a flange 214 of a motor shaft 216 that is coupled with rotatable portion 208. Motor shaft 216 may extend through a central aperture formed within fixed portion 206. Motor shaft 216 may be rotatable within the central aperture of fixed portion 206. For example, motor shaft 216 may be coupled with rotatable portion 208, such as using one or more fasteners (such as bolts or screws) that extend through a flange 214 of motor shaft 216 and into rotatable portion 208.

Motor shaft 216 may define a central aperture 218 through a length of motor shaft 216. Central aperture 218 may have a constant diameter in some embodiments or may have a variable diameter in other embodiments. For example, as illustrated central aperture 218 has a smaller diameter at a top end (e.g., near an injection inlet) and a larger diameter at lower end. In some embodiments, a transition between different diameters may be stepped, while in other embodiments the transition may be linearly and/or variably tapered. In some embodiments, one or more components of carrier head 202 may be disposed within central aperture 218. For example, carrier head 202 may include a shaft 220 that may have an upper end and a lower end. The lower end of shaft 220 may be coupled within an interior housing 260 of carrier head 202, while the upper end of shaft 220 may at least partially extend into central aperture 218. In some embodiments, the upper end of shaft 220 may include a bushing 224, which may be formed from and/or be coated with a low friction material. For example, all or a portion of bushing 224 may be formed from polytetrafluoroethylene (PTFE). In a particular embodiment, bushing 224 may be formed from a metal or polymeric material (such as polyetheretherketone (PEEK)) that is coated with PTFE. Bushing 224 may help facilitate substantially friction free vertical translation within central aperture 218 to provide lateral stability to help carrier head 202 handle lateral loads that are generated as the substrate moves against a top surface of a cleaning pad. Side surfaces of the top end of motor shaft 216 and bushing 224 may be spaced apart from inner walls of central aperture 218 such that a small air gap is present between the inner walls of central apertures 218 and the side surfaces of the top end of motor shaft 216 and bushing 224. The air gap may enable a fluid to be introduced into central aperture 218 via a fluid source 226 and passed downward through a bottom of central aperture 218 as described in greater detail below.

Cleaning system 200 may include a two-stage downforce actuator 228 that may be operable to vertically translate carrier head 202 and motor 204 between a raised position and a cleaning position. In the raised position, carrier head 202 may be spaced apart from a cleaning pad (not shown), which may enable a substrate to be loaded or unloaded from carrier head 202 and may enable carrier head 202 to be positioned over the cleaning pad. In the cleaning position, carrier head 202 may be lowered such that the substrate is in contact with and pressed against the cleaning pad for performance of cleaning operations. Downforce actuator 228 may include a first stage 230 that includes a linear actuator 231 that is operable to vertically translate carrier head 202 and motor 204 between the raised position and through an upper region of a vertical travel distance between the raised position and the cleaning position. For example, the upper region of the vertical travel distance may include at least an upper 50% of the travel distance, at least an upper 60% of the travel distance, at least an upper 70% of the travel distance, at least an upper 80% of the travel distance, at least an upper 90% of the travel distance, or more. Downforce actuator 228 may include a second stage 232 that includes an expandable flexure 234 that is operable to vertically translate carrier head 202 and motor 204 between the cleaning position and a lower region of the vertical distance between the raised position and the cleaning position. The lower region may include the remaining vertical distance that is not part of the upper region. For example, the lower region may include no greater than a bottom 50% of the travel distance, no greater than a bottom 40% of the travel distance, no greater than a bottom 30% of the travel distance, no greater than a bottom 20% of the travel distance, no greater than a bottom 10% of the travel distance, or less. Second stage 232 may be operable to apply additional downforce on carrier head 202 after carrier head 202 has contacted the cleaning pad. The additional force may result in downforce being applied to carrier head (and subsequently a substrate supported against carrier head 202) that facilitates cleaning of the substrate.

First stage 230 may be used to make a coarse adjustment to a vertical position of motor 204 and carrier head 202, such as by providing vertical travel over at least half of an upper portion of a vertical travel range of motor 204 and carrier head 202. First stage 230 may include one or more sliding components that may introduce sliding friction forces into first stage. However, since first stage 230 is not utilized to engage carrier head 202/a substrate with a cleaning pad or to apply downforce to the substrate, this sliding friction does not impact the total downforce applied to the substrate. Second stage 232 may be used to control vertical travel of carrier head 202 and the substrate along a final vertical travel distance to engage the substrate with the cleaning pad. Second stage 232 may use non-sliding components to provide precise, fine and repeatable adjustments to the downforce applied to the substrate.

As noted above, first stage 230 may include linear actuator 231. In some embodiments, linear actuator 231 may include a pneumatic actuator that may supply air to a bellow 236 that is coupled with housing 210. As air is pumped into bellow 236, bellow 236 may expand axially, such as in a downward direction. An upper end of bellow 236 may be fixed relative to housing 210, while a lower portion of bellow 236 may be free to move vertically relative to housing 210 A portion of bellow 236 (such as a lower portion of a bellow housing) may be coupled with a bracket 238 that may extend between and couple bellow 236 and fixed portion 206 of motor 204. As bellow 236 expands axially, bracket 238 may be pushed downward, which may force motor 204 to translate downward relative to housing 210. When bellow 236 is contracted (e.g., air is removed from bellow 236), bracket 238 is pulled upward to raise motor 204. Motor 204, and in particular fixed portion 206, may be coupled with one or more bearings and/or rails that may guide vertical translation of motor 204. First stage 230 may include one or more hard stops that limit vertical travel of motor 204 in a given direction.

As noted above, second stage 232 may include expandable flexure 234, which may be disposed within a chamber 240 that is formed within rotatable portion 208 of motor 204. In some embodiments, chamber 240 may be sized and shaped to be larger than expandable flexure 234, which may permit vertical expansion of expandable flexure 234 within chamber 240. Expandable flexure 234 may be coupled with rotatable portion 208 of motor 204 and with carrier head 202. For example, expandable flexure 234 may include an upper mounting hub 242 that may be coupled with rotatable portion 208 of motor 204. For example, one or more fasteners 244 may extend through and secure flange 214 of motor shaft 216 and upper mounting hub 242 of expandable flexure 234. In some embodiments, an upper surface of upper mounting hub 242 may contact a lower surface of motor shaft 216, flange 214, and/or an underside of shoulder 222 of shaft 220 of carrier head 202. Expandable flexure 234 may include a lower mounting hub 246 that may be coupled with shaft 220 of carrier head 202. For example, one or more fasteners 247 may extend through and secure a flange 250 of shaft 220 of carrier head 202 and lower mounting hub 246 of expandable flexure 234. Each mounting hub may define a central aperture that may receive shaft 220 of carrier head 202. The central aperture in upper mounting hub 242 may be slightly larger than shaft 220 such that an air gap is present through the aperture. A fluid, such as air, may be pumped through central aperture 218 of motor shaft 216, around bushing 224 and the top end of motor shaft 216, and enter an interior fluid chamber 248 of expandable flexure 234. The introduction of fluid into interior fluid chamber 248 may cause expandable flexure 234 to expand along a vertical axis, with upward expansion of expandable flexure 234 being limited by contact between the upper surface of upper mounting hub 242 and the underside of flange 214 of motor shaft 216. This contact may cause expandable flexure 234 to expand downward, with lower mounting hub 246 pushing flange 250 of shaft 220 of carrier head 202 downward. Downward movement of shaft 220 may push carrier head 202 downward to engage a substrate secured within carrier head 202 into contact with a cleaning pad. Expandable flexure may be further expanded to increase an amount of downforce applied to carrier head 202 and the substrate once the substrate is in contact with the cleaning pad.

In an initial state, motor 204 and carrier head 202 may be in a raised position in which motor 204 and carrier head 202 are spaced apart from a cleaning pad by a vertical distance as illustrated in FIG. 2A. In the raised position, bellow 236 may be in a contracted state and bracket 238 may support motor 204 in an elevated position. First stage 230 may be actuated to move motor 204 and carrier head 202 downward toward, but not touching, the cleaning pad as illustrated in FIG. 2B. As air or other fluid is introduced into bellow 236, bellow 236 may axially expand, which may force bracket 238 downward. The downward movement of bracket 238 may cause a corresponding downward movement of motor 204 and carrier head 202. The downward movement caused by first stage 230 may be limited via one or more hard stops. Once first stage 230 has been fully actuated, second stage 232 may be actuated to translate motor 204 and carrier head downward such that a substrate supported by carrier head 202 is in contact with the cleaning pad as illustrated in FIG. 2C. For example, air or other fluid may be introduced from a fluid source through central aperture 218 of motor shaft 216 and into interior fluid chamber 248 of expandable flexure 234 to inflate expandable flexure 234. The inflation of expandable flexure 234 may cause expandable flexure 234 to expand along a vertical axis and to push flange 250 of shaft 220 of carrier head 202 downward. Downward movement of shaft 220 may push carrier head 202 downward to engage a substrate secured within carrier head 202 into contact with a cleaning pad. Expandable flexure may be further expanded to increase an amount of downforce applied to carrier head 202 and the substrate once the substrate is in contact with the cleaning pad.

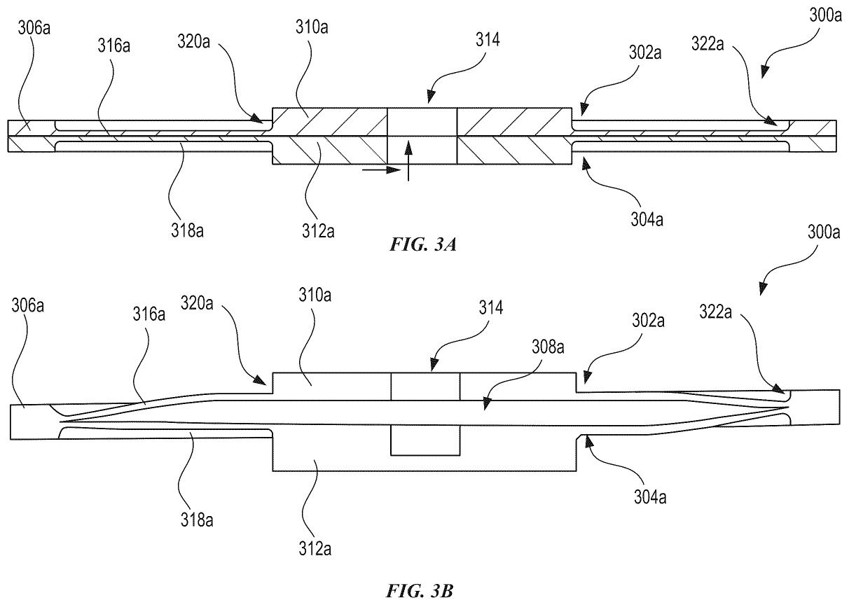

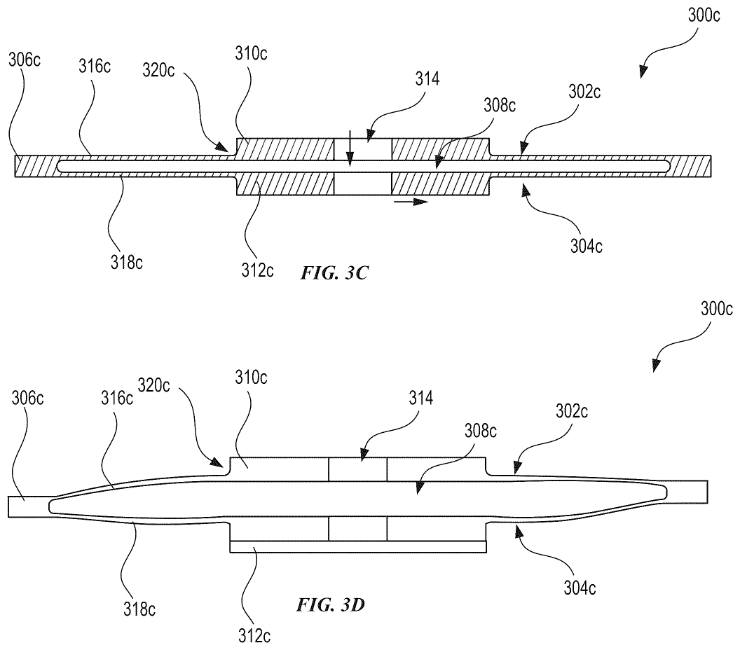

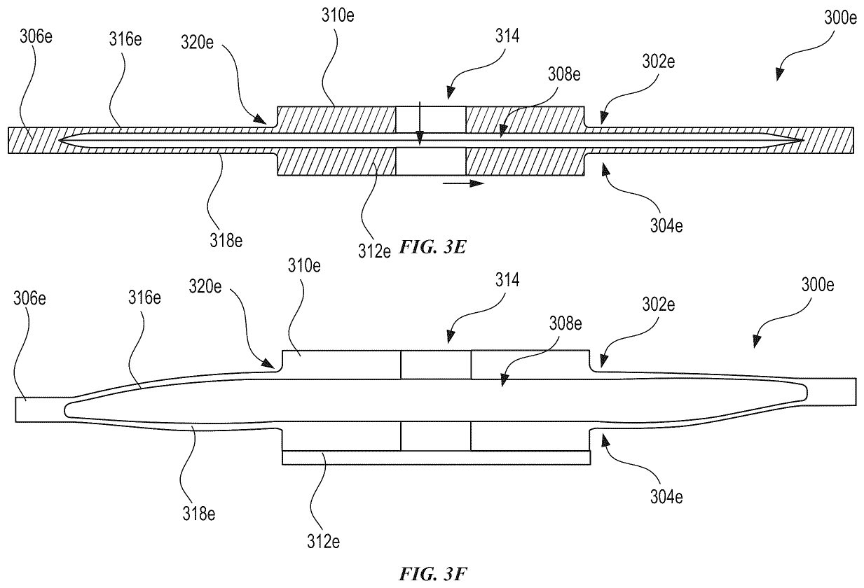

FIGS. 3A-3F illustrate cross-sectional side elevation views of exemplary expandable flexures 300 according to some embodiments of the present technology. Expandable flexures 300 may be used as expandable flexure 234 in cleaning system 200 or as an expandable flexure in any other cleaning system that would benefit from such technology. Each expandable flexure 300 may include a top wall 302 and a bottom wall 304 that are coupled together at a peripheral edge 306. Radially inward of peripheral edge 306, top wall 302 and bottom wall 304 may be unconnected such that an interior fluid chamber 308 is defined between inner surfaces of top wall 302 and bottom wall 304. Top wall 302 may include an upper mounting hub 310, which may be used to mount expandable flexure 300 to a motor (e.g., motor 204), such as by inserting one or more fasteners through upper mounting hub 310 and a shaft of the motor. Bottom wall 304 may include a lower mounting hub 312, which may be used to mount expandable flexure 300 to a carrier head (e.g., carrier head 202), such as by inserting one or more fasteners through lower mounting hub 312 and a shaft of the carrier head. Upper mounting hub 310 and lower mounting hub 312 may each define a central aperture 314, which may enable expandable flexure 300 to be mounted on a shaft of the carrier head, as well as may serve as a fluid inlet port for introducing air or another fluid into interior fluid chamber 308 to inflate or expand expandable flexure 300. Expandable flexure 300 may expand to vertically transfer the carrier head and the motor downward and may contract to vertically transfer the carrier head and the motor upward.

As illustrated, each expandable flexure 300 is a dual flexure, with portions of both top wall 302 and bottom wall 304 being designed to flex to accommodate expansion of interior fluid chamber 308 upon introduction of a fluid into interior fluid chamber 308. For example, top wall 302 may include an upper flexible wall 316 that extends between and couples peripheral edge 306 with upper mounting hub 310. Bottom wall 304 may include a lower flexible wall 318 that extends between and couples peripheral edge 306 with lower mounting hub 312. To enable upper flexible wall 316 and lower flexible wall 318 to flex while upper mounting hub 310, lower mounting hub 312, and peripheral 306 edge provide structural rigidity to expandable flexure 300, upper flexible wall 316 and lower flexible wall 318 may be thinner than upper mounting hub 310, lower mounting hub 312, and peripheral 306. For example, upper mounting hub 310 and lower mounting hub 312 may each have a thickness of between or about 3 mm and 10 mm, between or about 3.5 mm and 8 mm, or between or about 4 mm and 6 mm. Peripheral edge 306 may have a thickness of between or about 2 mm and 5 mm, or between or about 3 mm and 4 mm. Upper flexible wall 316 and lower flexible wall 318 may each have a thickness of between or about 1 mm and 2 mm, between or about 1.2 mm and 1.8 mm, or between or about 1.4 mm and 1.6 mm. Expandable flexure 300 may be formed from a material that may be sufficiently strong and rigid at larger thicknesses (e.g., at upper mounting hub 310 and lower mounting hub 312) to support mounting via one or more fasteners, while being sufficiently pliable or elastic at lower thicknesses (e.g., at upper flexible wall 316 and lower flexible wall 318) to flex to facilitate expansion of expandable flexure 300 when a fluid is introduced into interior fluid chamber 308. Such materials may include polymeric materials. In a particular embodiment, expandable flexure may be formed from polyetheretherketone (PEEK). In some embodiments, a diameter of expandable flexure 300 may be between or about 80 mm and 150 mm, between or about 90 mm and 135 mm, or between or about 100 mm and 120 mm, although other sizes of expandable flexures 300 may be used in various embodiments. In embodiments with diameters above these ranges, thicknesses of the various portions of the expandable flexures may be increased accordingly.

FIG. 3A illustrates expandable flexure 300a in a contracted state. Here, inner surfaces of top wall 302a and bottom wall 304a are in contact with one another such that interior fluid chamber 308a has essentially no volume. An annular transition region 320a between upper mounting hub 310a and upper flexible wall 316a may be tapered with a linear or variable slope. As illustrated, a variable, curved transition region 320a is provided. In some embodiments, a radius of transition region 320a may be between or about 10 mm and 40 mm, or between or about 15 mm and 30 mm, although other radii may be used in various embodiments. An annular transition region 322a between peripheral edge 306 and upper flexible wall 316 may be tapered with a linear or variable slope. As illustrated, a variable, curved transition region 322a is provided. In some embodiments, a radius of transition region 322a may be between or about 10 mm and 20 mm, or between or about 12 mm and 15 mm, although other radii may be used in various embodiments. Smaller transition radii may increase the stroke distance of expandable flexure 300a. FIG. 3B illustrates expandable flexure 300a in an inflated or expanded state. Here, inner surfaces of top wall 302a and bottom wall 304a are vertically spaced apart from one another such that interior fluid chamber 308a has an expanded volume. Expansion of interior fluid chamber 308a may push upper mounting hub 310a and lower mounting hub 312a vertically apart from one another, which may enable expandable flexure 300a to push a carrier head downward away from a motor as described elsewhere herein.

FIG. 3C illustrates expandable flexure 300c in a contracted state. Here, inner surfaces of top wall 302c and bottom wall 304c are vertically spaced apart from one another such that interior fluid chamber 308c forms a cavity between top wall 302c and bottom wall 304c. In the present embodiment, top and bottom boundaries of interior fluid chamber 308c may be substantially planar, while a peripheral edge of interior fluid chamber 308c may be rounded. An annular transition region 320c between upper mounting hub 310c and upper flexible wall 316c may be substantially stepped, but may include a fillet as shown here. In the illustrated embodiment, top surfaces of upper flexible wall 316c and peripheral edge 306c may be coplanar such that no transition region is needed. Similarly, bottom surfaces of lower flexible wall 318c and peripheral edge 306c may be coplanar. FIG. 3D illustrates expandable flexure 300c in an inflated or expanded state. Here, inner surfaces of top wall 302c and bottom wall 304c are vertically spaced apart from one another by a greater distance than in the contracted position such that interior fluid chamber 308c has an expanded volume. Expansion of interior fluid chamber 308c may push upper mounting hub 310c and lower mounting hub 312c vertically apart from one another, which may enable expandable flexure 300c to push a carrier head downward away from a motor as described elsewhere herein.

FIG. 3E illustrates expandable flexure 300e in a contracted state. Here, inner surfaces of top wall 302e and bottom wall 304e are vertically spaced apart from one another such that interior fluid chamber 308e forms a cavity between top wall 302e and bottom wall 304e. In the present embodiment, top and bottom boundaries of interior fluid chamber 308e may be substantially planar, while a peripheral edge of interior fluid chamber 308e may be tapered and may terminate in a point or a curve having a small radius. An annular transition region 320e between upper mounting hub 310e and upper flexible wall 316e may be substantially stepped, but may include a fillet as shown here. In the illustrated embodiment, top surfaces of upper flexible wall 316e and peripheral edge 306e may be coplanar such that no transition region is needed. Similarly, bottom surfaces of lower flexible wall 318e and peripheral edge 306e may be coplanar. FIG. 3F illustrates expandable flexure 300e in an inflated or expanded state. Here, inner surfaces of top wall 302e and bottom wall 304e are vertically spaced apart from one another by a greater distance than in the contracted position such that interior fluid chamber 308e has an expanded volume. Expansion of interior fluid chamber 308e may push upper mounting hub 310e and lower mounting hub 312e vertically apart from one another, which may enable expandable flexure 300e to push a carrier head downward away from a motor as described elsewhere herein.

As noted above, each expandable flexure 300 is a dual flexure that enables both the top and bottom walls to expand. Dual flexures may not only be operable to apply downforce to a carrier head and substrate in a uniform manner but may also be able to handle lateral forces and/or torque forces that are generated by rotational and/or lateral sweeping contact between the substrate and the cleaning pad during cleaning operations. In some embodiments, each expandable flexure 300 may be symmetrical, with top and bottom walls having an identical structure that is inverted relative to one another. In some embodiments, asymmetrical designs may be utilized. For example, expandable flexures may be used that promote expansion in a particular region and/or direction. For example, in some embodiments expandable flexures may be single flexure designs in which only one of top wall or bottom wall is expandable when a fluid is introduced into the interior fluid cavity 308. For example, top wall 302 may be thickened to prevent top wall 302 from expanding or otherwise flexing, while bottom wall 304 remains thin to enable expansion of bottom wall 304. It will be appreciated that other designs of expandable flexure are possible in various embodiments.

Expandable flexures, such as expandable flexures 234 and 300, may be formed from various processes. For example, top and bottom walls of each expandable flexure may be molded, cast, or otherwise separately formed. Peripheral edges of the top and bottom walls of the expandable flexure may then be joined, such as using an adhesive, fasteners, RF welding, and/or other joining technique that may produce an airtight seal at the peripheral edge of the expandable flexure. In some embodiments, a sealing element, such as an O-ring or gasket, may be provided between the different surfaces that are coupled together to form the peripheral edge. In some embodiments, expandable flexures may be produced using additive manufacturing techniques, which may enable the expandable flexures to be made as single-piece components that include no seams between the top and bottom walls. Such manufacturing techniques may therefore provide naturally airtight components that are stronger and do not require the use of additional sealing elements, such as O-rings.

In a particular embodiment, a 3D printer may be used to build up the structure of the expandable flexure layer by layer to create a monolithic expandable flexure structure. To produce the interior fluid chamber, a dissolvable support material may be positioned atop the bottom wall, such as while the peripheral edge is being formed. The dissolvable support material may be sized and shaped to match a thickness of the interior fluid chamber. For example, a thickness of the dissolvable support material may match a height of the interior fluid chamber when the expandable flexure is in a contracted state. In embodiments in which the interior fluid chamber is closed (e.g., top and bottom walls contact one another in the contracted state), the dissolvable support material may be a thin sheet of dissolvable paper or other material that enables the top wall to be printed or deposited atop the bottom wall without bonding to the bottom wall. Once the expandable flexure has been fully formed and cured, the expandable flexure may be exposed to a solvent to dissolve the support material, leaving only the final expandable flexure material. For example, the expandable flexure may be positioned within a bath of a solvent. In some embodiments the solvent may be agitated, such as by using a mechanical agitator and/or an ultrasonic agitator, which may help force the solvent into tight spaces of the interior fluid chamber. In some embodiments, expandable flexure may be at least partially expanded while exposed to the solvent to better enable the solvent to reach all surfaces defining the interior fluid chamber. For example, the expandable flexure may be inflated with a fluid and/or may be mechanically flexed by pulling the top wall and the bottom wall apart from one another. After dissolving the support structure, the solvent may be removed from the expandable flexure. For example, the expandable flexure may be dried, vacuumed, and/or otherwise treated to remove the solvent.

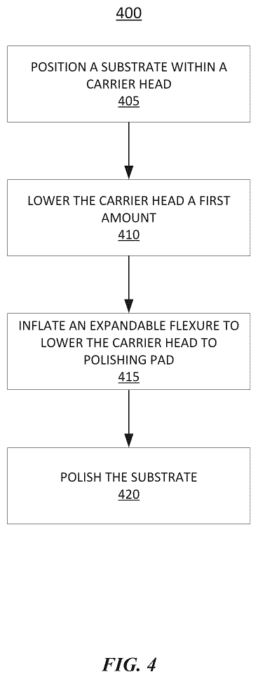

FIG. 4 shows exemplary operations in a method 400 for cleaning a substrate according to some embodiments of the present technology. Method 400 may be performed using a carrier head (such as carrier head 108 or carrier head 202), and a two-stage downforce actuator (such as downforce actuator 228) that includes an expandable flexure (such as expandable flexure 234 or expandable flexure 300) described herein. Method 400 may include operations prior to the substrate cleaning in some embodiments. For example, prior to the cleaning, a substrate may have one or more deposition and/or etching operations performed as well as any planarization or other process operations performed. Method 400 may include a number of operations that may be performed automatically within a system to limit manual interaction, and to provide increased efficiency and precision over manual operations. Method 400 may be performed as part of or in conjunction with a conventional cleaning process.

Method 400 may include positioning a substrate within a carrier head of a cleaning system at operation 405. For example, the substrate may be positioned against the substrate-receiving surface of a membrane of the carrier head. Method 400 may include lowering the carrier head and the substrate toward an upper surface of a cleaning pad without contacting the upper surface of the cleaning pad at operation 410. This may be done, for example, using a first stage of a downforce actuator. The first stage may include one or more sliding mechanisms that are driven by a pneumatic actuator. For example, air or other fluid may introduced into a bellow, causing the bellow to axially expand, which may force a bracket holding a motor and the carrier head downward along one or more bearings and/or sliding rails.

At operation 415, an expandable flexure of the cleaning system may be inflated to move the carrier head downward to press the substrate against the upper surface of the cleaning pad. This may involve, for example, pumping a fluid into an interior fluid chamber of the expandable flexure such that a bottom surface of the expandable flexure presses against an upper surface of the carrier head (e.g., a shaft of the carrier head) to press the carrier head and the substrate downward against the cleaning pad. The inflation may continue after the substrate is in contact with the cleaning pad, with increased inflation of the expandable flexure increasing an amount of downforce applied to the substrate.

At operation 420, the substrate may be cleaned against the upper surface of the cleaning pad. For example, the carrier head may rotate and/or translate (or sweep) the substrate about the surface of the cleaning pad such that abrasive particles within a cleaning slurry supplied to the cleaning pad may gradually remove material from a surface of the substrate in a desired pattern and/or to achieve a desired film thickness profile. In some embodiments, in addition to or alternatively to the carrier head rotating and/or translating, the cleaning pad may rotate and/or translate.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or ±0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or ±0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a heater” includes a plurality of such heaters, and reference to “the protrusion” includes reference to one or more protrusions and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A chemical mechanical cleaning system, comprising:
a carrier head;
a motor that is coupled with the carrier head, the motor being operable to rotate the carrier head about a central axis of the carrier head;
a two-stage downforce actuator that is operable to vertically translate the carrier head and the motor between a raised position and a cleaning position, wherein the two-stage downforce actuator comprises:
a first stage that comprises a linear actuator that is operable to vertically translate the carrier head and the motor between the raised position and at least an upper 50% of a vertical travel distance between the raised position and the cleaning position; and
a second stage that comprises an expandable flexure that is operable to vertically translate the carrier head and the motor between the cleaning position and no greater than a lower 50% of the vertical distance between the raised position and the cleaning position.

2. The chemical mechanical cleaning system of claim 1, wherein:
the linear actuator comprises a pneumatic actuator.

3. The chemical mechanical cleaning system of claim 1, wherein:
the expandable flexure expands to vertically transfer the carrier head and the motor downward;
the expandable flexure contracts to vertically transfer the carrier head and the motor upward; and
a top end of the expandable flexure defines a fluid inlet port.

4. The chemical mechanical cleaning system of claim 3, wherein:
the fluid inlet port is fluidly coupled with a fluid source.

5. The chemical mechanical cleaning system of claim 1, wherein:
a top end of the expandable flexure is coupled with a shaft of the motor and a bottom end of the expandable flexure is coupled with a shaft of the carrier head.

6. The chemical mechanical cleaning system of claim 5, wherein:
a portion of a carrier head shaft that extends above the expandable flexure comprises a shoulder that forms a hard stop when a top surface of the expandable flexure presses against the shoulder.

7. The chemical mechanical cleaning system of claim 1, wherein:
the expandable flexure comprises a dual flexure that comprises an expandable top surface and an expandable bottom surface.

8. The chemical mechanical cleaning system of claim 1, wherein:
the expandable flexure comprises:
a peripheral edge;
an upper mounting hub that is coupled with the motor;
an upper flexible wall that extends between and couples the peripheral edge with the upper mounting hub;
a lower mounting hub that is coupled with the carrier head; and
a lower flexible wall that extends between and couples the peripheral edge with the lower mounting hub.

9. The chemical mechanical cleaning system of claim 1, wherein:
the first stage comprises a hard stop that limits a downward travel position of the linear actuator.

10. The chemical mechanical cleaning system of claim 1, further comprising:
a cleaning pad disposed below the carrier head.

11. The chemical mechanical cleaning system of claim 1, wherein:
the expandable flexure comprises polyetheretherketone (PEEK).

12. A two-stage downforce actuator, comprising:
a first stage that comprises a linear actuator that is operable to vertically translate a carrier head and a motor between a raised position and at least an upper 50% of a vertical travel distance between the raised position and a cleaning position; and
a second stage that comprises an expandable flexure that is operable to vertically translate the carrier head and the motor between the cleaning position and no greater than a lower 50% of the vertical distance between the raised position and the cleaning position.

13. The two-stage downforce actuator of claim 12, wherein:
the expandable flexure expands to vertically transfer the carrier head and the motor downward; and
the expandable flexure contracts to vertically transfer the carrier head and the motor upward.

14. The two-stage downforce actuator of claim 12, wherein:
the expandable flexure defines an interior fluid chamber between a top wall and a bottom wall of the expandable flexure.

15. The two-stage downforce actuator of claim 14, wherein:
in a contracted state, inner surface of the top wall and inner surface of the bottom wall are in contact.

16. The two-stage downforce actuator of claim 14, wherein:
in a contracted state, inner surface of the top wall and inner surface of the bottom wall are vertically spaced apart.

17. The two-stage downforce actuator of claim 14, wherein:
a peripheral edge of the expandable flexure that extends about an interior fluid chamber of the expandable flexure comprises thickened walls relative to flexible portions of the top wall and the bottom wall that bound the interior fluid chamber.

18. The two-stage downforce actuator of claim 14, wherein:
the top wall of the expandable flexure comprises an upper mounting hub; and
the bottom wall of the expandable flexure comprises a lower mounting hub.

19. A method of cleaning a substrate, comprising:
positioning a substrate within a carrier head of a cleaning system;
lowering the carrier head and the substrate toward an upper surface of a cleaning pad without contacting the upper surface of the cleaning pad;
inflating an expandable flexure of the cleaning system to move the carrier head downward to press the substrate against the upper surface of the cleaning pad; and
cleaning the substrate against the upper surface of the cleaning pad.

20. The method of cleaning a substrate of claim 19, wherein:
inflating the expandable flexure comprises pumping a fluid into an interior fluid chamber of the expandable flexure such that a bottom surface of the expandable flexure presses against an upper surface of the carrier head to press the carrier head and the substrate downward against the cleaning pad.
